(19) United States
(12) Patent Application Publication
(10) Pub. No.: US 2026/0226872 A1
(43) Pub. Date: Aug. 6, 2026

(54) AERONAUTICAL PROPULSION SYSTEM COMPRISING AN OPTIMIZED FAN SECTION

(71) Applicant: SAFRAN AIRCRAFT ENGINES, Paris (FR)

(72) Inventors: Matthieu Pierre Michel DUBOSC, Moissy-Cramayel (FR); Guillaume Olivier Vartan MARTIN, Moissy-Cramayel (FR); Didier René André ESCURE, Moissy-Cramayel (FR)

(73) Assignee: SAFRAN AIRCRAFT ENGINES, Paris (FR)

(21) Appl. No.: 19/151,138

(22) PCT Filed: Jan. 26, 2024
(86) PCT No.: PCT/FR2024/050109

§ 371 Date: Sep. 15, 2025

(30) Foreign Application Priority Data
Jan. 26, 2023 (FR) FR 2300742

(51) Int. Cl. F02K 3/06

(52) U.S. Cl. CPC F02K 3/06; F05D 2200/13; F05D 2200/14; F05D 2200/221; F05D 2220/323

(57) ABSTRACT

A fan section of a propulsion system includes a fan rotor including twenty-two blades and having a solidity greater than or equal to 0.9 and less than or equal to 1.3, where the solidity is equal to a ratio between a chord at the tip of a blade and an inter-blade pitch at the tip of the blade. The fan section has a pressure ratio greater than or equal to 1.05 and less than or equal to 1.5, and a peripheral speed at the tip of the blade greater than or equal to 270 m/s and less than or equal to 380 m/s. The pressure ratio and the peripheral speed are measured at cruising power.

### TECHNICAL FIELD

The present disclosure generally relates to the field of propulsion systems, and more particularly to aeronautical propulsion systems having a high or even very high bypass ratio.

### BACKGROUND

A propulsion system generally includes, from upstream to downstream in the direction of gas flow, a fan section, a compressor section that may comprise a low-pressure compressor and a high-pressure compressor, a combustion chamber and a turbine section that may comprise in particular a high-pressure turbine and a low-pressure turbine. The high-pressure compressor is driven in rotation by the high-pressure turbine via a high-pressure shaft. The fan and, where applicable, the low-pressure compressor are driven in rotation by the low-pressure turbine via a low-pressure shaft.

Technological research efforts have already led to very significant improvements in the environmental performance of airplanes. The Applicant takes into account the factors that have an impact on all design and development phases to obtain less energy-intensive and more environmentally friendly aeronautical components and products whose integration and use in civil aviation have moderate environmental consequences, with the aim of improving the energy efficiency of airplanes.

Thus, in order to improve the propulsive efficiency of the propulsion system and reduce its specific consumption as well as the noise emitted by the fan section, propulsion systems with a high bypass ratio BPR (corresponding to the ratio between the flow rate of the secondary air stream and the flow rate of the primary air stream) have been proposed. To achieve such bypass ratios, the fan section can be decoupled from the low-pressure turbine, thus making it possible to independently optimize their respective rotation speed. Generally, the decoupling is achieved using a reduction mechanism placed between the upstream end of the low-pressure shaft and a rotor of the fan section. The rotor of the fan section is then driven by the low-pressure shaft via the reduction mechanism at a rotation speed lower than that of the low-pressure shaft.

The improvement of the propulsive efficiency of the system may also involve the dimensioning of the fan section. Indeed, due to its large diameter (in particular in order to achieve high bypass ratios and low fan pressure ratios), the fan section represents a significant portion of the propulsion system in terms of mass and therefore specific consumption. At the same time, the fan section produces a very large portion of the thrust of the propulsion system.

### DISCLOSURE

One aim of the present application is to optimize the fan section of the propulsion system in order to make it more efficient without excessively penalizing the mass and therefore the specific consumption of the propulsion system.

To this end, according to a first aspect, there is provided a fan section of an aeronautical propulsion system, the fan section comprising a fan rotor comprising twenty-two blades and having a solidity greater than or equal to 0.9 and less than or equal to 1.3, preferably greater than or equal to 1.0 and less than or equal to 1.3, where the solidity is equal to a ratio between a chord at the tip of the blade and an inter-blade pitch at the tip of the blade, the fan section having:
a pressure ratio greater than or equal to 1.05 and less than or equal to 1.5; and
a peripheral speed at the tip of the blade greater than or equal to 260 m/s and 400 m/s;
the pressure ratio and peripheral speed being measured at cruising power.

Some preferred but non-limiting characteristics of the fan section according to the first aspect are as follows, taken individually or in combination:
a diameter of the fan rotor is greater than or equal to 127 cm and less than or equal to 304.8 cm, for example greater than or equal to 215.9 cm and less than or equal to 304.8 cm, for example of the order of 228.6 cm;
the peripheral speed at the tip of the blades is greater than or equal to 270 m/s and less than or equal to 380 m/s;
the fan section has a hub-to-tip ratio greater than or equal to 0.22 and less than or equal to 0.32, for example greater than or equal to 0.235 and less than or equal to 0.30, for example still less than or equal to 0.27;
the fan section is housed in a fan casing and the blades of the fan rotor are fixed in rotation relative to a hub of the fan rotor so as to have a fixed setting; and/or
the fan section further comprises a fan stator comprising at least 38 stator vanes and at most 48 stator vanes, for example exactly 40 stator vanes.

According to a second aspect, there is proposed an aeronautical propulsion system comprising:
a drive shaft movable in rotation about an axis of rotation;
a fan shaft;
a fan section according to the first aspect, the fan rotor being driven in rotation by the fan shaft;
and
a reduction mechanism coupling the drive shaft and the fan shaft in order to drive the fan shaft at a rotation speed lower than the rotation speed of the drive shaft.

Some preferred but non-limiting characteristics of the aeronautical propulsion system according to the second aspect are the following, taken individually or in combination:
a thrust density per blade of the fan rotor of the fan section is greater than or equal to 0.5×10⁴ and less than or equal to 3.0×10⁴ N/m², where the thrust density per blade is defined by the following formula:

$$Thrust density = \frac{FN}{n * {D}^{2}} * 100$$

and where: FN is the thrust generated p by the propulsion system and is measured when the propulsion system is at cruising power and is expressed in Newton; n is the number of blades in the fan rotor and is equal to twenty-two; and D is the diameter of the fan rotor, measured in a plane normal to the axis of rotation at an intersection between the tip and a leading edge of the blades of the fan rotor, and is expressed in meters;
a bypass ratio of the propulsion system is greater than or equal to 10, for example comprised between 10 and 35 inclusive, for example between 10 and 18 inclusive;
a drive turbine comprises at least three and at most five stages;
a compressor comprises at least two and at most four stages;
the propulsion system further comprises a high-pressure turbine and a high-pressure compressor connected via a high-pressure shaft, the high-pressure shaft rotating faster than the drive shaft, the high-pressure turbine being a two-stage turbine; and/or
the high-pressure compressor comprises at least eight and at most eleven stages;

According to a third aspect, there is provided an aircraft comprising at least one propulsion system according to the second aspect, fixed to the aircraft via a mast.

According to a fourth aspect, there is provided a method for dimensioning or manufacturing a fan section of an aeronautical propulsion system, the fan section comprising a fan rotor comprising twenty-two blades and having a solidity greater than or equal to 0.9 and less than or equal to 1.3, preferably greater than or equal to 1.0 and less than or equal to 1.3, where the solidity is equal to a ratio between a chord at the tip of the blade and an inter-blade pitch at the tip of the blade, the fan section having:
a pressure ratio greater than or equal to 1.05 and less than or equal to 1.5; and
a peripheral speed at the tip of the blade greater than or equal to 260 m/s and 400 m/s;
the pressure ratio and the peripheral speed being measured at cruising power.

Some preferred but non-limiting characteristics of the aeronautical propulsion system according to the second aspect are the following, taken individually or in combination:
the fan section is further dimensioned such that a thrust density per blade of the fan rotor of the propulsion system is greater than or equal to 0.5×10⁴ and less than or equal to 3.0×10⁴ N/m² where the thrust density per blade of the fan rotor is defined by the following formula:

$$Thrust density = \frac{FN}{n * {D}^{2}} * 100$$

and where: FN is the thrust generated by the propulsion system and is measured when the propulsion system is stationary at cruising power and is expressed in Newton; n is the number of blades in the fan rotor and is equal to twenty-two; and D is the fan diameter, measured in a plane normal to the axis of rotation at an intersection between the tip and a leading edge of the blades of the fan rotor, and is expressed in meters.

### DESCRIPTION OF THE FIGURES

Other characteristics, aims and advantages of the present disclosure will emerge from the following description which is purely illustrative and non-limiting and which should be read in relation to the appended drawings, in which:

FIG. 1 is a schematic, partial and sectional view of one example of a propulsion system in accordance with a first embodiment;

FIG. 2a is a partial and schematic sectional view of one example of a fan rotor of a propulsion system in accordance with one embodiment, the section being made in a plane passing through an upstream point of intersection between a tip and a leading edge of two adjacent blades;

FIG. 2b is a perspective view of one example of a fan rotor of a propulsion system in accordance with one embodiment;

FIG. 3 is a schematic sectional view of one example of a reduction mechanism according to a first variant;

FIG. 4 is a schematic sectional view of one example of a planetary reduction mechanism according to a second variant;

FIG. 5 is one example of an aircraft that may comprise at least one propulsion system in accordance with one embodiment;

FIG. 6 is a flowchart illustrating examples of steps in a dimensioning or manufacturing method in accordance with one embodiment.

Throughout the figures, similar elements bear identical references.

### DETAILED DESCRIPTION

A propulsion system 1 has a main direction extending along a longitudinal axis X and comprises, from upstream to downstream in the direction of gas flow in the propulsion system 1 when in operation, a fan section 2 and a primary body 3, often called “gas generator”, including a compressor section 4, 5, a combustion chamber 6 and a turbine section 7, 8. The propulsion system 1 is here an aeronautical propulsion system 1 configured to be fixed to an aircraft 100 via a pylon (or mast).

The compressor section 4, 5 comprises a succession of stages each comprising a blade wheel (rotor) 4a, 5a rotating in front of a vane wheel (stator) 4b, 5b. The turbine section 7, 8 also comprises a succession of stages each comprising a vane wheel (stator) 7b, 8b, behind which a blade wheel (rotor) 7a, 8a rotates.

In the present application, the axial direction corresponds to the direction of the longitudinal axis X, in correspondence with the rotation of the gas generator shafts, and a radial direction is a direction perpendicular to this axis X and passing therethrough. Moreover, the circumferential (or lateral or tangential) direction corresponds to a direction perpendicular to the longitudinal axis X and not passing therethrough. Unless otherwise specified, the terms “inner” (respectively, internal) and “outer” (respectively, external), respectively, are used with reference to a radial direction so that the inner portion or face of an element is closer to the axis X than the outer portion or face of the same element.

In operation, an air stream F entering the propulsion system 1 is divided between a primary air stream F1 and a secondary air stream F2, which circulate from upstream to downstream in the propulsion system 1.

The secondary air stream F2 (also called “bypass air stream”) flows around the primary body 3. The secondary air stream F2 allows cooling the periphery of the primary body 3 and serves to generate most of the thrust provided by the propulsion system 1.

The primary air stream F1 flows in a primary path inside the primary body 3, passing successively through the compressor section 4, 5, the combustion chamber 6 where it is mixed with fuel to serve as an oxidizer, and the turbine section 7, 8. The passage of the primary air stream F1 through the turbine section 7, 8 receiving energy from the combustion chamber 6 causes rotation of the rotor of the turbine section 7, 8, which in turn drives in rotation the rotor of the compressor section 4, 5 as well as a rotor portion 9 of the fan section 2.

In a two-spool propulsion system 1, the compressor section 4, 5 may comprise a low-pressure compressor 4 and a high-pressure compressor 5. The turbine section 7, 8 may comprise a high-pressure turbine 7 and a low-pressure turbine 8. The rotor of the high-pressure compressor 5 is driven in rotation by the rotor of the high-pressure turbine 7 via a high-pressure shaft 10. The rotor of the low-pressure compressor 4 and the rotor portion 9 of the fan section 2 are driven in rotation by the rotor of the low-pressure turbine 8 via a low-pressure shaft 11. Thus, the primary body 3 comprises a high-pressure body comprising the high-pressure compressor 5, the high-pressure turbine 7 and the high-pressure shaft 10, and a low-pressure body comprising the fan section 2, the low-pressure compressor 4, the low-pressure turbine 8 and the low-pressure shaft 11. The rotation speed of the high-pressure body is greater than the rotation speed of the low-pressure body. In a triple-spool propulsion system 1, the turbine section 7, 8 further comprises an intermediate turbine, positioned between the high-pressure turbine 7 and the low-pressure turbine 8 and configured to drive the rotor of the low-pressure compressor 4 via an intermediate shaft. The fan rotor 9 and the rotor of the high-pressure compressor 5 remain driven by the low-pressure shaft 11 and the high-pressure shaft 10, respectively.

The low-pressure shaft 11 is generally housed, over a part of its length, in the high-pressure shaft 10 and is coaxial with the high-pressure shaft 10. The low-pressure shaft 11 and the high-pressure shaft 10 may be co-rotating, that is to say driven in the same direction about the longitudinal axis X. As a variant, the low-pressure shaft 11 and the high-pressure shaft are counter-rotating, that is to say driven in opposite directions about the longitudinal axis X. Where appropriate, the intermediate shaft is housed between the high-pressure shaft 10 and the low-pressure shaft 11. The intermediate shaft and the low-pressure shaft 11 may be co-rotating or counter-rotating.

The fan section 2 comprises at least the fan rotor 9 capable of being driven in rotation relative to a stator portion of the propulsion system 1 by the turbine section 7, 8. Each fan rotor 9 comprises a hub 13 and blades 14 extending radially from the hub 13. The blades 14 of each rotor 9 may be fixed relative to the hub 13.

The fan section 2 may further comprise a fan stator 16, or straightener, which comprises vanes 17 mounted on a hub of the fan stator 16 and have the function of straightening the secondary air stream F2 which flows at the outlet of the fan rotor 9. The vanes 17 of the fan stator 18 may be fixed relative to the hub or have a variable setting.

In order to improve the propulsive efficiency of the propulsion system 1 and to reduce its specific consumption as well as the noise emitted by the fan section 2, the propulsion system 1 has a high bypass ratio. By high bypass ratio, it is meant here a bypass ratio greater than or equal to 10, for example comprised between 10 and 80 inclusive. To calculate the bypass ratio, the mass flow rate of the secondary air stream F2 and the mass flow rate of the primary air stream F1 are measured when the propulsion system 1 is stationary, uninstalled, in take-off rating in a standard atmosphere (as defined by the International Civil Aviation Organization (ICAO) manual, Doc 7488/3, 3^{rd} edition) and at sea level (conditions known as SLS, for Seal Level Standard). By “uninstalled” it will be meant here that the measurements are performed when the propulsion system 1 is in a test bench (and uninstalled on an aircraft 100), the measurements then being simpler to make.

It should be noted that, in the present application, some parameters are determined in cruising condition that is to say at an altitude of 10,668 m (35,000 feet), 0.8 Mach and in ISA (International Standard Atmosphere) conditions defined by the standard ISO2533/1975 edition/1985 addendum. In addition, the distances (length, radius, diameter, etc.) are measured at room temperature (around 20° C.) when the propulsion system 1 is cold, that is to say when the propulsion system 1 is stopped from a sufficient period for the parts of the propulsion system to be at room temperature, it being understood that these dimensions vary little compared to the conditions in which the propulsion system 1 is in take-off rating.

The fan rotor 9 is decoupled from the low-pressure shaft 11 using a reduction mechanism 19, placed between an upstream end of the low-pressure shaft 11 and the fan rotor 9, in order to independently optimize their respective rotation speed. In this case, the propulsion system 1 further comprises an additional shaft, called fan shaft 20. The low-pressure shaft 11 connects the low-pressure turbine 8 to an inlet of the reduction mechanism 19 while the fan shaft 20 connects the outlet of the reduction mechanism 19 to the fan rotor 9. The fan rotor 9 is therefore driven by the low-pressure shaft 11 via the reduction mechanism 19 and the fan shaft 20 at a rotation speed lower than the rotation speed of the low-pressure turbine 8.

This decoupling makes it possible to reduce the rotation speed and the pressure ratio of the fan rotor 9 and to increase the power extracted by the low-pressure turbine 8. Indeed, the overall efficiency of the propulsion systems is conditioned to the first order by the propulsive efficiency, which is favorably influenced by minimizing the variation of the kinetic energy of the air at the crossing of the propulsion system 1. In a propulsion system 1 with a high bypass ratio, most of the flow rate generating the propulsive force is constituted by the secondary air stream F2 of the propulsion system 1, the kinetic energy of the secondary air stream F2 being mainly affected by the compression that the secondary air stream F2 undergoes during the crossing of the fan section 2. The propulsive efficiency and the pressure ratio of the fan section 2 are therefore linked: the lower the pressure ratio of the fan section 2, the better the propulsive efficiency.

The propulsion system 1 is configured to provide a thrust comprised between 18,000 lbf (80,068 N) and 51,000 lbf (222,411 N), for example between 20,000 lbf (88,964 N) and 35,000 lbf (155,688 N), when the propulsion system 1 is stationary, uninstalled, in take-off rating in a standard atmosphere (as defined by the International Civil Aviation Organization (ICAO) manual, Doc 7488/3, 3^{rd} edition) and at sea level.

The fan section 2 can comprise a fan casing 12, the fan rotor 9 being housed in the fan casing 12.

The fan rotor 9 extends upstream of a fan stator. The vanes of the fan stator are then generally referred to as outlet guide vanes (OGV) and have a fixed setting relative to the hub of the fan stator. Moreover, the bypass ratio of the propulsion system 1 is for example greater than or equal to 10, for example comprised between 10 and 35 inclusive, for example between 10 and 18 inclusive.

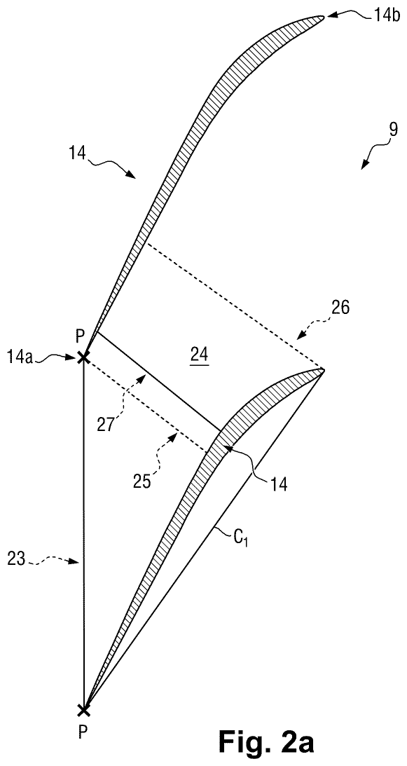

Each fan blade 14 has a leading edge 14a and a trailing edge 14b (see for example FIGS. 2a and 2b). The leading edge 14a is configured to extend facing the flow of gases entering the fan rotor 9. It corresponds to the anterior portion of an aerodynamic profile which faces the air stream and which divides the air flow into an intrados flow and an extrados flow. The trailing edge 28b corresponds to the posterior portion of the aerodynamic profile, where the intrados and extrados flows meet. It should be noted here that, when the blades 14 comprise a leading edge and/or trailing edge shield, the leading edge 14a (respectively the trailing edge 14b) of the blades 14 corresponds to the anterior portion of the profile of the shield which reconstitutes the leading edge (respectively the posterior portion of the profile of the shield which reconstitutes the trailing edge 14b) and whose function is to divide the flow into an intrados flow and an extrados flow (respectively to join the flows).

The fan rotor 9 further comprises a series of platforms each extending between two adjacent blades 14 and configured to radially delimit on the inside the air stream F passing through the rotor 9.

The fan blade 14 further has a chord at the blade tip c₁ and a chord at the blade root c₂.

The chord at the blade tip c₁ corresponds to the line segment that connects an upstream point of intersection P between the leading edge 14a and the tip 21 of a blade 14 and a downstream point of intersection between the trailing edge 14b and the tip 21 of the blade 14.

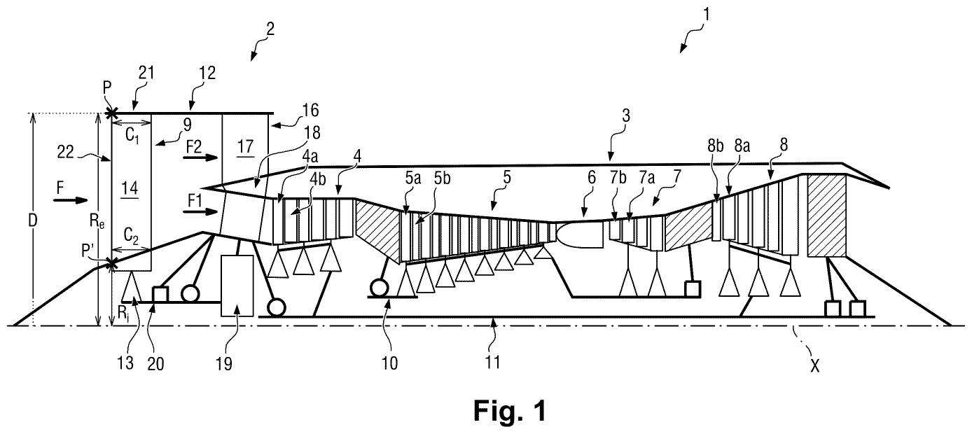

The chord at the blade root c₂ corresponds to the line segment parallel to the axis of rotation X that connects a second downstream point of intersection between the trailing edge 14b and the surface that radially delimits on the inside the flow path in the fan rotor 9 (and corresponds to the point of connection of the trailing edge 14b with the aerodynamic surface of a platform of the fan rotor 9) and a second upstream point of intersection P′ between the leading edge 14a and a plane circumferential to the axis X that comprises the second downstream point of intersection. The second upstream and downstream points of intersection are therefore at the same distance from the axis X (same radius). The second upstream point of intersection P′ also extends at a distance from the aerodynamic surface of the platform, as shown in FIG. 1, given as a purely illustrative example.

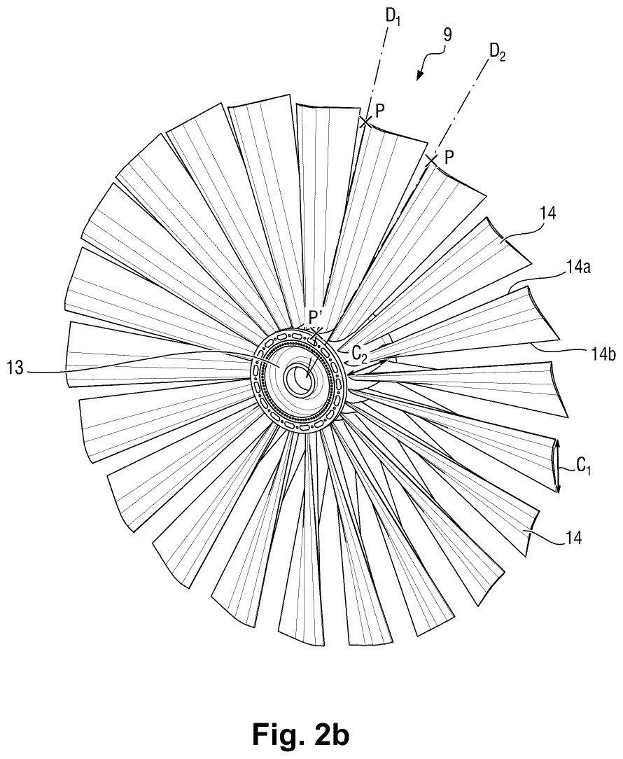

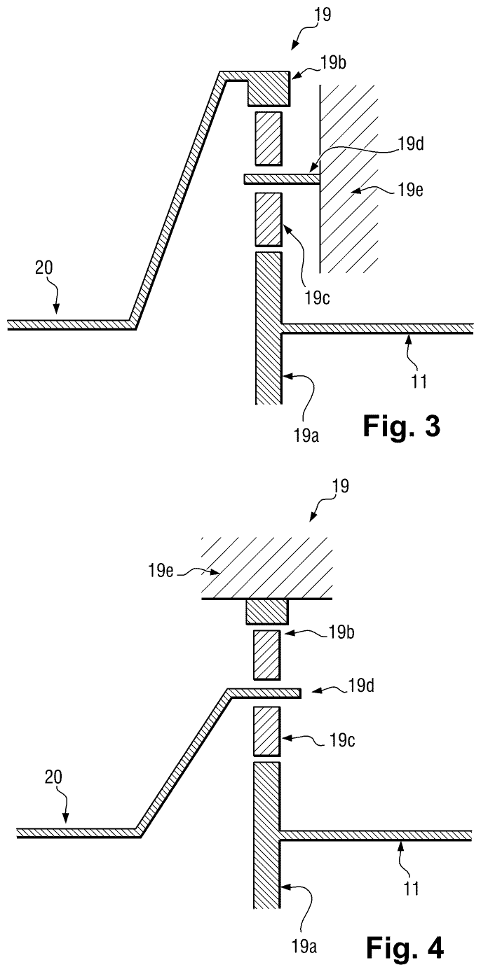

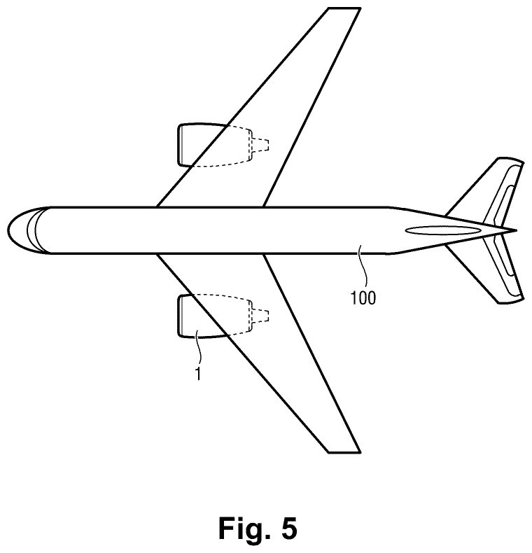

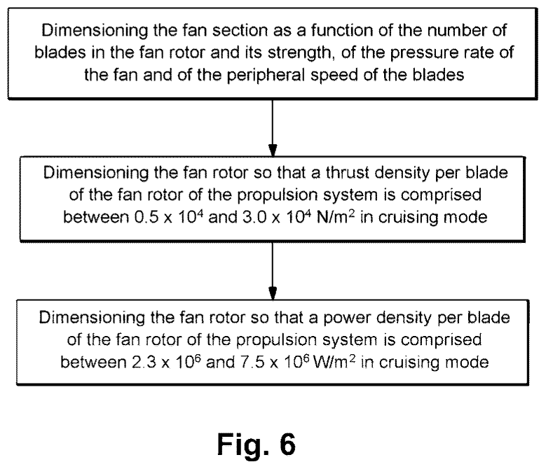

The reduction mechanism 19 may comprise a reduction mechanism 19 with a planetary gear train, for example of the “planetary” or “star” type, according to the encountered terminology of those skilled in the art, single-staged or two-staged. According to a first variant, the reduction mechanism 19 may be of the star type (FIG. 3) and comprise a sun gear pinion 19a (inlet of the reduction mechanism 19), centered on an axis of rotation X of the reduction mechanism 19 (generally coincident with the longitudinal axis X) and configured to be driven in rotation by the low-pressure shaft 11, a ring gear 19b (outlet of the reduction mechanism 19) coaxial with the sun gear pinion 19a and configured to drive in rotation the fan shaft 20 about the axis of rotation X, and a series of planet gears 19c circumferentially distributed about the axis of rotation X between the sun gear pinion 19a and the ring gear 19b, each planet gear 19c being meshed internally with the sun gear pinion 19a and externally with the ring gear 19b. The series of planet gears 19c is mounted on a planet gear carrier 19d which is fixed relative to a stator portion 19e of the propulsion system 1, for example relative to a casing of the compressor section 4, 5. According to a second variant, the reduction mechanism 19 can be of the planetary type (FIG. 4), in which case the ring gear 19b is fixedly mounted on the stator portion 19e of the propulsion system 1 and the fan shaft 20 is driven in rotation by the planet gear carrier 19d (which is therefore movable in rotation relative to a stator portion 19e of the propulsion system 1, for example relative to a casing of the compressor section 4, 5).

Regardless of the configuration of the reduction mechanism 19, the diameter of the ring gear 19b and of the planet gear carrier 19d are greater than the diameter of the sun gear pinion 19a, such that the rotation speed of the fan rotor 9 is lower than the rotation speed of the low-pressure shaft 11.

The reduction ratio of the reduction mechanism 19 is greater than or equal to 2.5 and less than or equal to 11, for example greater than or equal to 2.7 and less than or equal to 6.0, for example around 3.0.

The two-spool propulsion system 1 may in particular comprise a two-stage high-pressure turbine 7, a high-pressure compressor 5 comprising at least eight stages and at most eleven stages, a low-pressure turbine 8 comprising at least three stages and at most five stages, and a low-pressure compressor 4 comprising at least two stages and at most four stages.

The redline speed of the low-pressure shaft 11, which corresponds to the absolute maximum speed likely to be encountered by the low-pressure shaft 11 during the entire flight (according to the European certification regulation EASA CS-E 740 (or according to the American certification regulation 14-CFR Part 33.87), is comprised between 8,500 revolutions per minute and 12,000 revolutions per minute, for example between 9,000 revolutions per minute and 11,000 revolutions per minute, when the propulsion system 1 is stationary, uninstalled, in take-off rating in a standard atmosphere (as defined by the International Civil Aviation Organization (ICAO) manual, Doc 7488/3, 3^{rd} edition) and at sea level. The redline speed corresponds to the maximum rotation speed when the propulsion system 1 is sound (and potentially at the end of its life). It is therefore likely to be reached by the low-pressure shaft 11 in flight conditions. This redline speed forms part of the data declared in the engine certification (type certificate data sheet). Indeed, this rotation speed is usually used as a reference speed for the dimensioning and manufacture of the propulsion systems 1 and in some certification tests (such as blade loss or rotor integrity tests, typically CS-E-800 certification-bird strike and ingestion).

In order to optimize the performance of the propulsion system 1, the fan rotor 9 includes exactly twenty-two blades 14. Moreover, a pressure ratio of the fan section 2 is greater than or equal to 1.05 and less than or equal to 1.5, a solidity of the fan rotor 9 is greater than or equal to 0.9 and 1.3, preferably between 1.0 and 1.3, where the solidity is equal to a ratio between a chord at the blade tip and an inter-blade pitch 23, and a peripheral speed at the blade tip is greater than or equal to 260 m/s and 400 m/s, for example greater than or equal to 270 m/s and less than or equal to 380 m/s. it should be noted that the pressure ratio of the fan section 2 and the peripheral speed are measured here at cruising power insofar as it is the flight phase in which it is desired to obtain the maximum efficiency of the fan rotor 9.

The solidity is equal to the ratio between the chord at the blade tip c₁ and an inter-blade pitch 23. The inter-blade pitch 23 corresponds to the angular distance between the upstream points of intersection P of two adjacent blades 14; the inter-blade pitch 23 is therefore equal to the outer radius Rₑ of the fan rotor 9 (half-diameter) multiplied by the angle between a first straight line D₁, comprised in a plane normal to the axis X which comes from the upstream point of intersection P (see FIGS. 2a and 2b) of a first blade 14 and intersects the axis X, and a second straight line D₂, comprised in the plane normal to the axis X which comes from the upstream point of intersection P of a second blade 14 immediately adjacent to the first blade 14 and intersects the axis X. Since the solidity is a ratio of distances, it is measured when the propulsion system 1 is cold (under the aforementioned conditions) (see FIG. 2b).

The pressure ratio of the fan section 2 corresponds to the ratio between the average pressure at the outlet of the fan stator 17 and the average pressure at the inlet of the fan rotor 9. For example, the pressure ratio is greater than or equal to 1.1 and less than or equal to 1.45. The average pressures are measured here on the flow path (from the surface that radially delimits on the inside the flow path at the inlet of the fan rotor 9 to the fan casing 12.

The selection of a number of fan blades 14 equal to twenty-two allows obtaining an optimized fan section 2 participating in the reduction of the specific consumption and the mass of the propulsion system 1. Certainly, this number of blades 14 is higher than in conventional propulsion systems with a high bypass ratio. However, the increase of the number of blades 14 (in comparison with the conventional propulsion systems 1 with a high bypass ratio) to twenty-two allows in practice reducing the footprint of the fan rotor 9 and plays a role in the reduction of the mass and the chord at the tip c₁ of each fan blade 14. Thus, the mass of the fan rotor 9 does not drastically increase in comparison with a fan rotor 9 having a smaller number of blades 14. However, the reduction of the mass and the chord c₁ of the fan blades 14 allows reducing the unbalance generated by a possible fan blade out, and therefore simplifying and lightening the structures necessary for holding the fan rotor 9 in the event of blade loss as well as for retaining the blades 14 (simplification and lightening of the fan casing 12). The noise generated by the fan rotor 9 is also lower. In addition, the fan blades 14 being less bulky and angularly closer to each other, in the event of ingestion of objects (and in particular birds), the size of the objects at the outlet of the rotor 9 is smaller, which allows reducing the thickness of the fan blades 14 while meeting the requirements of the current certifications in terms of ingestion (typically CS-E-800 certification-bird strike and ingestion).

The solidity of the fan rotor 9 comprised between 0.9 and 1.3, preferably between 1.0 and 1.3, is specifically adapted to a rotor 9 comprising exactly twenty-two blades 14. In a propulsion system 1 with a reduction mechanism 19, the rotation speed of the fan rotor 9 is reduced, here comprised between 260 m/s and 400 m/s. Its pressure ratio can also be reduced and is here comprised between 1.05 and 1.5, for example between 1.1 and 1.45, so that the speed difference between the outlet of the fan rotor 9 and the inlet of the fan rotor 9 is reduced while optimizing the efficiency of the fan section 2. The flow at the tip of the blade 14 through the fan rotor 9 is then supersonic. Particularly, a supersonic shock is generated at the level of the fan blades 14.

However, this supersonic shock cannot be eliminated, in particular in cruising mode: it must therefore be controlled to prevent it from deteriorating the efficiency of the fan section 2. By dimensioning and manufacturing the fan rotor 9 with twenty-two blades so that its solidity is greater than or equal to 0.9 and less than or equal to 1.3, the inter-blade pitch 23 and the chord at the blade tip c₁ are such that the supersonic shock is stable at cruising power and moves only in the divergent portion of the inter-blade channel 24. The inter-blade channel 24 corresponds to the passage between two adjacent blades 14 which extends between an inlet plane 25, which is normal to the air stream F at the inlet of the fan rotor 9 and passes through the leading edge 14a of the first blade 14, and an outlet plane 26 which is parallel to the inlet plane and passes through the trailing edge 14b of the second blade 14 (see for example FIG. 2a). This channel 24 has, from upstream to downstream through the fan rotor 9, a convergent portion, which extends from the inlet plane 25 to an intermediate plane 27 corresponding to the minimum section of the channel 24 (neck), and a divergent portion, which extends from the intermediate plane 27 to the outlet plane 26. However, the Applicant has noted that, when the supersonic shock reaches the convergent portion of the inter-blade channel 24, it becomes unstable and has the effect of reducing the efficiency of the fan section 2. Conversely, when the supersonic shock remains in the divergent portion, for example by being in the vicinity of the intermediate plane 27, the supersonic shock is stable at cruising power. The longer the inter-blade channel 24, that is to say the greater the distance between the inlet 25 and outlet 26 planes, the easier it is to design a convergent-divergent channel and therefore maintain the supersonic shock in the divergent portion of the channel 24; however, the increase of the length of the inter-blade channel 24 has the consequence of increasing the chord at the blade tip c₁, and therefore of increasing the mass of the fan rotor 9 (and consequently the specific consumption of the propulsion system 1) and reducing the efficiency of the fan section 2. It will be noted particularly that the length of the inter-blade channel 24 and the chord are linked to the inter-blade pitch by the solidity of the fan rotor 9. For a fan rotor 9 with twenty-two blades, a solidity comprised between 0.9 and 1.3 is then a good compromise between the length of the inter-blade channel 24 in order to control the supersonic shock in the fan rotor 9 and the efficiency of the fan section 2.

The diameter D of the fan rotor can then be comprised between 80 inches (203.2 cm) and 185 inches (469.9 cm) inclusive. The diameter D is for example comprised between 85 inches (215.9 cm) and 120 inches (304.8 cm) inclusive, for example of the order of 90 inches (228.6 cm), which allows integrating the propulsion system 1 in a conventional manner, particularly under the wing of an aircraft 100. The diameter of the fan rotor 9 is measured here in a plane normal to the axis of rotation X at the upstream point of intersection P (between the tip 21 and the leading edge 14a of the blades 14 of the fan rotor 9) and is expressed in meters (m). it should be noted that since FIG. 1 is a partial view, the diameter D is only partially visible.

The number of vanes 16 in the fan stator 17 depends on the acoustic criteria defined for the propulsion system 1 and is at least equal to the number of blades 14 of the fan rotor 9. In one embodiment, the number of vanes 16 in the fan stator 17 is at least equal to 38 and at most equal to 48, for example exactly equal to 40.

The fan rotor 9 also has a hub-to-tip ratio comprised between 0.22 and 0.32, for example. In the case of a fixed-setting fan rotor 9, the hub-to-tip ratio may be comprised between 0.22 and 0.30, for example between 0.235 and 0.27. The hub-to-tip ratio corresponds to the ratio between the inner radius Ri and the outer radius Rₑ of the fan rotor 9. The inner radius Ri corresponds to the distance between the axis of rotation X and the point of intersection between the leading edge 22 and the surface which radially delimits on the inside the flow path at the inlet of the fan rotor 9 (and corresponds to the point of connection of the leading edge 22 with the aerodynamic surface of the platform of the fan rotor 9). The outer radius Rₑ is equal to half the fan diameter D. The lower the hub-to-tip ratio, the more efficient the fan rotor 9 is. However, the reduction of the hub-to-tip ratio of the fan rotor 9 involves an increase in the mechanical load of the hub 13 of the fan rotor 9. The dimensioning and manufacture of the fan rotor 9 such that its hub-to-tip ratio is comprised between 0.22 and 0.32 allows particularly obtaining an optimized thrust density per fan blade 14. Particularly, the thrust density per blade 14 of the fan rotor 9 may be greater than or equal to 0.5×10⁴ and less than or equal to 3.0×10⁴ N/m² where the thrust density per blade 14 is defined by the following formula:

$$Thrust density = \frac{FN}{n * {D}^{2}} * 100$$

and where: FN is the thrust generated by propulsion system 1 and is expressed in Newton (N) and is measured when the propulsion system 1 is at cruising speed (10,668 m altitude, 0.8 Mach and in ISA conditions);
   n is the number of blades 14 in the fan rotor 9 and is equal to twenty-two; and
   D is the diameter of the fan rotor 9.

The Applicant found that, when the thrust density per blade in cruising mode is less than 0.5×10⁴, it was difficult to integrate the propulsion system 1 because it was too bulky, had too much mass and generated excessive drag. Moreover, when the thrust density is greater than 3.0×10⁴ N/m², the performance of the propulsion system 1 in terms of specific consumption is degraded. The dimensioning and manufacture of the propulsion system 1 such that the thrust density per blade 14 of the fan rotor 9 is comprised between 0.5×10⁴ and 3.0×10⁴ N/m² at cruising power therefore allows obtaining a compromise between the integration and the performance of the propulsion system 1 when the propulsion system 1 comprises a reduction mechanism 19 and has a high bypass ratio. Such a thrust density range per blade 14 is furthermore compatible with a fan pressure ratio of less than 1.45, which allows optimizing the propulsive efficiency of the propulsion system 1.

For example, a propulsion system 1 according to the present disclosure comprising a ducted fan rotor and whose thrust density per fan blade 14 is equal to 1.6×10⁴ N/m² at cruising power has a specific consumption lower by 15% compared to the same propulsion system whose thrust density per fan blade is equal to 4×10⁴ N/m². The dimensioning and manufacture of the propulsion system 1 so as to obtain a thrust density per blade 14 comprised between 0.5×10⁴ and 3.0×10⁴ N/m² 3.3×10⁴ at cruising power can be achieved by first fixing the thrust generated by the fan section 2 and by modifying the diameter (D) of the fan rotor (and therefore the pressure rate of the fan section 2). Compared to a propulsion system with a conventional reduction mechanism, the diameter D can for example be increased and the pressure rate of the fan 2 can be reduced. The rotation speed of the fan rotor 9 can also be adapted in order to meet performance, acoustic and integration requirements. Depending on the aerodynamic characteristics of the fan section 2, the propulsion system 1 can be modified so as to integrate a pitch change mechanism 15 making it possible to adapt the setting of the blades 14 of the rotor 9 (and possibly the vanes 16 of the stator 17) of the fan section 2. Moreover, depending on the integrated performance balance (fuel consumption balance of the propulsion system 1 integrated into the aircraft (mass, specific consumption, drag)) and the aircraft constraints (in terms of integration and program constraint), the fan section 2 can be ducted or unducted (and comprise a single fan rotor 9 or two counter-rotating fan rotors 9). Finally, the thermodynamic cycle is adapted to the different parameters thus dimensioned (fan diameter, number of blades, pressure rate of the fan section 2, etc.) of the propulsion system 1: particularly the flow rate of the gas generator can be reduced and the reduction ratio of the reduction mechanism 19 can be increased.

### Example

The engine 1 is a two-spool propulsion system 1 comprising a ducted fan section 2 conforming to the teaching of the present application.

| Dimensioning parameter (SLS unless otherwise | | |
|---|---|---|
| specified) | Engine 1 | |
| Solidity | 0.9 | |
| Peripheral speed of the fan blades | 343 | m/s |
| Number of fan blades | 22 | |
| Hub-to-tip ratio | 0.30 | |
| Thrust density per fan blade (cruise) | 9.14 × 10⁵ | |
| Fan pressure ratio | 1.37 | |
| Engine thrust (cruise) | 20,451N | |
| Diameter D | 2.413 m (95 in.) | |
| Bypass ratio BPR | 12, 0 | |
| Redline speed of the fan rotor 9 | 2,842 | rpm |
| Redline speed of the high-pressure shaft 10 | 19,741 | rpm |
| Redline speed of the low-pressure shaft 11 (N₁) | 10,143 | rpm |
| Compression rate of the low-pressure | 1.85 | |
| compressor | | |
| Overall compression rate | 50 | |
| Reduction ratio | 3.57 | |
| Number of stages of the low-pressure | 2 | |
| compressor 4 | | |
| Number of stages of the high-pressure | 10 | |
| compressor 5 | | |
| Number of stages of the high-pressure turbine 7 | 2 | |
| Number of stages of the low-pressure turbine 8 | 3 | |
| Inlet temperature of the high-pressure turbine 7 | 1,627° | C. |
| Inlet temperature of the low-pressure turbine 8 | 1,024° | C. |
| (redline) | | |

| | |
|---|---|
| N₁²S (where S is the outlet section of the low- | 48.6 × 10⁶ (rpm)² · m² |
| pressure turbine 8) | |

The engine 1 has low solidity and comprises a number of blades equal to 22. The consequence is that the chord of the fan blades of the engine 2 is reduced compared to a conventional engine over the entire height of the blade. This chord reduction allows reducing the mass of the fan and fan disk of the engine 1, as well as the drag of the nacelle (gain due to the axial chord distance).

The unbalance in the event of blade loss is also reduced. The fan blades of the engine 1 can be in particular made of a composite material comprising a fibrous reinforcement embedded in a polymer matrix. The fibers of the fibrous reinforcement can be hybridized (use of different fibers in the reinforcement of localized manner) in order to modify the frequency placement.

In order to obtain the engine 1 (compliant with the disclosure) from a conventional engine, the diameter D of the fan and the bypass ratio BPR were increased, which made it possible to improve the propulsive efficiency and to maintain a comparable thrust given the reduction in the pressure ratio of the fan 2. Moreover, the overall compression rate was increased as well as the inlet temperature of the high-pressure turbine 7, which made it possible to increase the thermal efficiency of the propulsion system 1. Finally, insofar as the temperature of the low-pressure turbine 8 was kept stable, it was possible to increase its mechanical loading (N₁²S) and therefore reduce the number of stages.

1. A fan section of a propulsion system, the fan section comprising:
a fan rotor comprising exactly twenty-two blades and having a solidity greater than or equal to 0.9 and less than or equal to 1.3, where the solidity is equal to a ratio between a chord at the tip of a blade and an inter-blade pitch at the tip of the blade,
wherein the fan section has:
a pressure ratio greater than or equal to 1.05 and less than or equal to 1.5; and
a peripheral speed at the tip of the blade greater than or equal to 270 m/s and less than or equal to 380 m/s, and
wherein the pressure ratio and the peripheral speed are measured at cruising power.

2. The fan section according to claim 1, wherein a diameter of the fan rotor is greater than or equal to 127 cm and less than or equal to 304.8 cm.

3. (canceled)

4. The fan section according to claim 1, wherein the fan section has a hub-to-tip ratio greater than or equal to 0.22 and less than or equal to 0.32.

5. The fan section according to claim 1, wherein the fan section is housed in a fan casing, and
wherein the twenty-two blades of the fan rotor are fixed in rotation relative to a hub of the fan rotor so as to have a fixed setting.

6. The fan section according to claim 1, further comprising a fan stator comprising at least 38 stator vanes and at most 48 stator vanes.

7. A propulsion system comprising:
a drive shaft movable in rotation about an axis of rotation;
a fan shaft;
the fan section according to claim 1, the fan rotor being driven in rotation by the fan shaft; and
a reduction structure that couples the drive shaft and the fan shaft in order to drive the fan shaft at a rotation speed lower than a rotation speed of the drive shaft.

8. The propulsion system according to claim 7, wherein a thrust density per blade of the fan rotor of the fan section is greater than or equal to 0.5×10⁴ and less than or equal to 3.0×10⁴ N/m², where the thrust density per blade is defined by the following formula:
$$Thrust density = \frac{FN}{n * {D}^{2}} * 100$$
and where:
FN is a thrust generated by the propulsion system and is measured when the propulsion system is at cruising power and is expressed in Newton;
n is a number of blades in the fan rotor and is equal to twenty-two; and
D is a diameter of the fan rotor, measured in a plane normal to the axis of rotation at an intersection between a tip and a leading edge of the twenty-two blades of the fan rotor, and is expressed in meters.

9. The propulsion system according to claim 7, wherein a bypass ratio of the propulsion system is greater than or equal to 10.

10. The propulsion system according to claim 7, wherein further comprising a drive turbine configured to drive the fan shaft, the drive turbine comprising at least three and at most five stages.

11. The propulsion system according to claim 7, wherein the drive turbine further drives a compressor that comprises at least two and at most four stages.

12. The propulsion system according to claim 7, further comprising a high-pressure turbine and a high-pressure compressor connected via a high-pressure shaft,
wherein the high-pressure shaft rotates faster than the drive shaft, and
wherein the high-pressure turbine is a two-stage turbine.

13. The propulsion system according to claim 12, wherein the high-pressure compressor comprises at least eight and at most eleven stages.

14. An aircraft comprising at least one of the propulsion system according to claim 7,
wherein the at least one of the propulsion system is fixed to the aircraft via a mast.

15. A operating method for operating a fan section of a propulsion system, the fan section comprising a fan rotor comprising exactly twenty-two blades and having a solidity greater than or equal to 0.9 and less than or equal to 1.3, where the solidity is equal to a ratio between a chord at a tip of a blade and an inter-blade pitch at the tip of the blade,
wherein the fan section has:
a pressure ratio greater than or equal to 1.05 and less than or equal to 1.5; and
a peripheral speed at the tip of the blade greater than or equal to 270 m/s and less than or equal to 380 m/s, and
wherein the pressure ratio and the peripheral speed are measured at cruising power,
the method comprising operating the fan section of the propulsion system.

16. The operating method according to claim 15, wherein the fan section is further dimensioned such that a thrust density per blade of the fan rotor of the propulsion system is greater than or equal to 0.5×10⁴ and less than or equal to 3.0×10⁴ N/m² where the thrust density per blade of the fan rotor is defined by the following formula:
$$Thrust density = \frac{FN}{n * {D}^{2}} * 100$$
and where:
FN is a thrust generated by the propulsion system and is measured when the propulsion system is stationary at cruising power and is expressed in Newton;
n is a number of blades in the fan rotor and is equal to twenty-two; and
D is the fan diameter, measured in a plane normal to the axis of rotation at an intersection between the tip and a leading edge of the twenty-two blades of the fan rotor, and is expressed in meters,
wherein the fan section that has been dimensioned is operated.

17. The fan section according to claim 1, wherein a diameter of the fan rotor is greater than or equal to 215.9 cm and less than or equal to 304.8 cm.

18. The fan section according to claim 1, wherein the fan section has a hub-to-tip ratio greater than or equal to 0.235 and less than or equal to 0.30.

19. The propulsion system according to claim 7, wherein a bypass ratio of the propulsion system is comprised between 10 and 35 inclusive.

20. A manufacturing method of a fan section of a propulsion system, the manufacturing method comprising:
dimensioning the fan section, wherein the fan section comprises a fan rotor comprising exactly twenty-two blades and having a solidity greater than or equal to 0.9 and less than or equal to 1.3, where the solidity is equal to a ratio between a chord at a tip of a blade and an inter-blade pitch at the tip of the blade, wherein the fan section has:
a pressure ratio greater than or equal to 1.05 and less than or equal to 1.5; and
a peripheral speed at the tip of the blade greater than or equal to 270 m/s and less than or equal to 380 m/s, and
wherein the pressure ratio and the peripheral speed are measured at cruising power; and
manufacturing the fan section that has been dimensioned.
